(19) United States
(12) Patent Application Publication
(10) Pub. No.: US 2010/0123361 A1
(43) Pub. Date: May 20, 2010

(54) MOTOR

(75) Inventor: Ho-Kyung Jang, Suwon-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/505,847

(22) Filed: Jul. 20, 2009

(30) Foreign Application Priority Data
Nov. 14, 2008 (KR) 10-2008-0113634

(51) Int. Cl. H02K 7/08

(52) U.S. Cl. 310/90

(57) ABSTRACT

A motor is disclosed. The motor in accordance with an embodiment of the present invention includes: a rotor, a shaft, which is coupled to the rotor; a plate, which is coupled to an outer circumference of the shaft; a bearing, which supports the shaft such that the shaft can rotate; a cap, which is coupled to the bearing such that an edge of the plate is covered; a lubricant, which is filled between the shaft and the bearing; and a sealing part, which is coupled to an inner side of the cap and in which the sealing part is made of a transparent material such that an amount of the lubricant filled can be checked. Therefore, the amount of the lubricant filled between the shaft and the bearing can be directly checked.

### CROSS-REFERENCE TO RELATED APPLICATIONS

This application claims the benefit of Korean Patent Application No. 10-2008-0113634, filed with the Korean Intellectual Property Office on Nov. 14, 2008, the disclosure of which is incorporated herein by reference in its entirety.

### BACKGROUND

1. Technical Field

The present invention relates to a motor.

2. Description of the Related Art

Currently, spindle motors are applied in various mobile products, such as mobile phones, PMPs, game players and MP3s. Accordingly, recent years have seen the reduction in the size of the spindle motor.

In response to a trend toward smaller spindle motors, a hydrodynamic bearing is widely used in the spindle motor. However, there are a number of difficulties in injecting a lubricant into the smaller spindle motor and implementing a sealing structure thereof.

Particularly, when injecting the lubricant into the spindle motor, injecting a certain amount of lubricant may cause a problem, significantly deteriorating the reliability of the spindle motor. If the amount of the lubricant injected into the spindle motor is insufficient, the life of the spindle motor can be shortened. Likewise, if the amount of the lubricant injected into the spindle motor is excessive, it may cause a breakdown of the spindle motor due to the leakage of lubricant.

Therefore, controlling a steady amount of the lubricant injected into the spindle motor has become one of the major tasks for improving the reliability of the spindle motor.

### SUMMARY

The present invention provides a motor that can check the amount of a lubricant filled.

An aspect of the present invention provides a motor. The motor in accordance with an embodiment of the present invention includes: a rotor, a shaft, which is coupled to the rotor; a plate, which is coupled to an outer surface of the shaft; a bearing, which supports the shaft such that the shaft can rotate; a cap, which is coupled to the bearing such that an edge of the plate is covered; a lubricant, which is filled between the shaft and the bearing; and a sealing part, which is coupled to an inner side of the cap and in which the sealing part is made of a transparent material such that an amount of the lubricant filled can be checked.

An end of the sealing part can be tapered toward the shaft: A supporting protrusion can be formed on a lower surface of the sealing part, in which the supporting protrusion is protruded downward, and a flowing groove can be radially formed on a lower surface of the sealing part.

A supporting protrusion can be formed on a lower surface of the cap, in which the lower surface faces the plate and the supporting protrusion is protruded downward. A flowing groove can be radially formed on a lower surface of the cap, in which the lower surface faces the plate.

The bearing can be a hydrodynamic bearing, and a dynamic pressure groove can be formed on an inner circumference of the hydrodynamic bearing, in which the dynamic pressure groove is tilted from the axis of the shaft. Moreover, a through-hole can be formed on the bearing, in which the through-hole penetrates through the bearing vertically such that the lubricant flows.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a cross-sectional view illustrating a spindle motor in accordance with an embodiment of the present invention.

FIG. 2 is a cross-sectional view illustrating a hydrodynamic bearing of a spindle motor in accordance with an embodiment of the present invention.

FIG. 3 is a bottom view illustrating a cap of a spindle motor in accordance with an embodiment of the present invention.

FIG. 4 is a magnified view illustrating a portion of a spindle motor in accordance with an embodiment of the present invention.

FIG. 5 is a cross-sectional view illustrating a portion of a spindle motor in accordance with another embodiment of the present invention.

FIG. 6 is a bottom view illustrating a cap of a spindle motor in accordance with another embodiment of the present invention.

FIG. 7 is a cross-sectional view illustrating a portion of a spindle motor in accordance with yet another embodiment of the present invention.

FIG. 8 is a bottom view illustrating a cap of a spindle motor in accordance with yet another embodiment of the present invention.

### DETAILED DESCRIPTION

The features and advantages of this invention will become apparent through the below drawings and description.

A spindle motor according to certain embodiments of the present invention will be described below in more detail with reference to the accompanying drawings. Those components that are the same or are in correspondence are rendered the same reference numeral regardless of the figure number, and redundant descriptions are omitted.

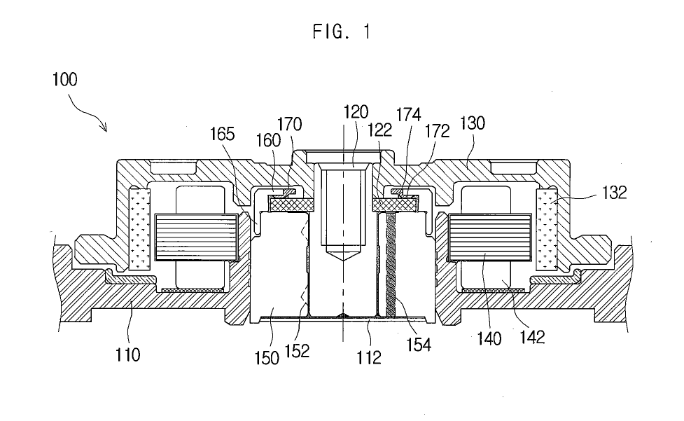

FIG. 1 is a cross-sectional view illustrating a spindle motor 100 in accordance with an embodiment of the present invention. The spindle motor 100 in accordance with an embodiment of the present invention can include: a rotor 130; a shaft 120, which is coupled to the rotor 130; a plate 122, which is coupled to an outer circumference of the shaft 120; a bearing 150, which supports the shaft 120 such that the shaft 120 can rotate; a cap 160, which is coupled to the bearing 150 such that an edge of the plate 122 is covered; a lubricant, which is filled between the shaft 120 and the bearing 150; and a sealing part 170, which is coupled to an inner side of the cap 160. The sealing part 170 can be made of a transparent material such that the amount of the lubricant filled can be determined. Thus, the amount of the lubricant filled between the shaft 120 and the bearing 150 can be directly checked.

Coupled to the shaft 120 is the rotor 130, which is a part to be rotated relatively with respect to a stator 140. A hole can be formed in the middle of the rotor 130, and the shaft 120 is inserted in the hole and thus coupled to the hole. The rotor 130 covers the stator 140, and a part extended downward is formed on an outer circumference of the rotor 130. Then, a magnet 132 is coupled to an inner circumference of the part extended downward. The magnet 132 faces an outer circumference of the stator 140 and can generate a driving force through an electromagnetic interaction with the stator 140.

The rotor 130 is coupled to one side of the shaft 120, and the other side of the shaft 120 is supported by the bearing 150, which is a hydrodynamic bearing, such that the shaft 120 can rotate. An end of the shaft 120 is vertically supported by a thrust washer 112.

The hydrodynamic bearing 150 supports the outer circumference of the shaft 120 such that the shaft 120 can rotate. An outer circumference of the bearing 150 is supported by a base 110. A hole is formed in the middle of the base 110 such that the bearing 150 can be inserted in the hole, and an inner circumference of the stator 140 is coupled to an outer circumference of the hole.

The stator 140 is shaped like a ring surrounding the outer circumference of the bearing 150, and a coil 142 is wound on the stator 140. The outer circumference of the stator 140 faces a magnet 132, and the driving force is provided to the rotor 130 through the electromagnetic interaction between the magnet 132 and the stator 140.

The plate 122 is coupled to the outer circumference of the shaft 120 such that an upper side of the bearing 150 is covered. The cap 160 is coupled to the upper side of the bearing 150 such that the edge of the plate 122 is covered. The cap 160 covers the edge of the plate 122, thereby preventing the shaft 120 from detaching.

Additionally, the cap 160 covers the upper side of the bearing 150 and the edge of the plate 122, so that the lubricant filled between the shaft 120 and the bearing 150 can be prevented from leaking. It shall be evident that the cap 160 can be coupled to the base 110 in some cases such that the edge of the plate 122 is covered.

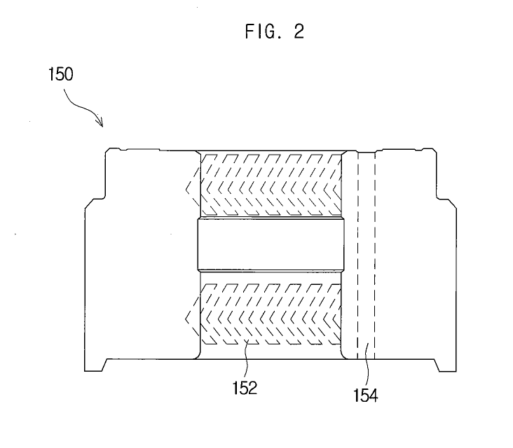

FIG. 2 is a cross-sectional view illustrating the hydrodynamic bearing 150 of the spindle motor 100 in accordance with an embodiment of the present invention. As illustrated in FIG. 2, a dynamic pressure groove 152 is formed on an inner circumference of the hydrodynamic bearing 150, on which the dynamic pressure groove 152 is tilted from the axis of the shaft 120. The dynamic pressure groove 152 can guide a flow of the lubricant filled between the shaft 120 and the bearing 150 in a desired direction when the shaft 120 rotates. Fluid pressure by the flow of such lubricants is called dynamic pressure, and the dynamic pressure groove 152 can provide the dynamic pressure of the lubricant more efficiently.

Additionally, a through-hole 154 penetrating through the bearing 150 vertically can be formed on the bearing 150 such that the lubricant can flow vertically through the bearing 150. The through-hole 154 provides a path by which the lubricants can freely circulate through the bearing 150, thereby reducing the pressure difference between the lubricants inside the spindle motor 100. Likewise, the through-hole 154 can provide a path through which bobbles that may be present inside the lubricants can be discharged to the upper side of the hydrodynamic bearing 150.

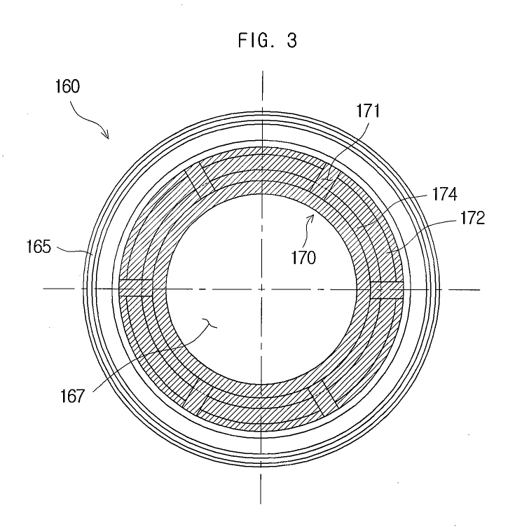

FIG. 3 is a bottom view illustrating the cap 160 of the spindle motor 100 in accordance with an embodiment of the present invention. As illustrated in FIGS. 1 and 3, the cap 160 can be shaped like a ring having a hollow part 167 formed in the middle thereof. A lower side of the cap 160 has a part extended downward 165 to be coupled to the upper side of the bearing 150, and an upper side of the cap 160 is shaped like a circular disk extended inward to cover the edge of the plate 122.

The sealing part 170 is made of a transparent material such that the amount of the lubricant filled between the bearing 150 and the shaft 120 can be checked. The sealing part 170 is coupled to an inner end of the cap 160. The sealing part 170 can be made of a material that can transmit the light, for example, plastic resin.

The lubricant is filled between the bearing 150 and the shaft 120, more particularly in a space surrounded by the bearing 150, the shaft 120, the plate 122 and the cap 160. Since the sealing part 170 is made of a transparent material, the amount of the lubricant filled inside the spindle motor 100 can be seen with the naked eye.

Therefore, the sealing part 170 can control the amount of the lubricant filled inside the spindle motor 100 more precisely, and thus the leakage of the lubricant by an effect of excessive or insufficient lubricant in the spindle motor 100 or potential shortening of life-span of the spindle motor 100 can be solved.

Therefore, the amount of the lubricant filled inside the spindle motor 100 can be more directly controlled, improving the reliability of the spindle motor 100.

A supporting protrusion 172, which is protruded downward, is formed on a lower surface of the sealing part 170. The supporting protrusion 172 can be formed in a shape of a ring in accordance with the shape of the cap 160. The supporting protrusion 172 reduces a contact area between the plate 122 and the sealing part 170, allowing the rotor 130 to rotate smoothly. Since the supporting protrusion 172 is formed on the lower surface of the sealing part 170 made of a plastic material, processing the cap 160 made of a hard metal material can be performed more easily.

A flowing groove 171 can be radially formed on the lower surface of the sealing part 170. Each of the flowing grooves 171 can be radially extended and provide a path through which the lubricants and the bubbles can move along the circumference.

An end of the sealing part 170 is tapered toward the shaft 120. Therefore, toward the shaft 120, a lower surface of the end of the sealing part 170 can be increasingly separated from the plate 122.

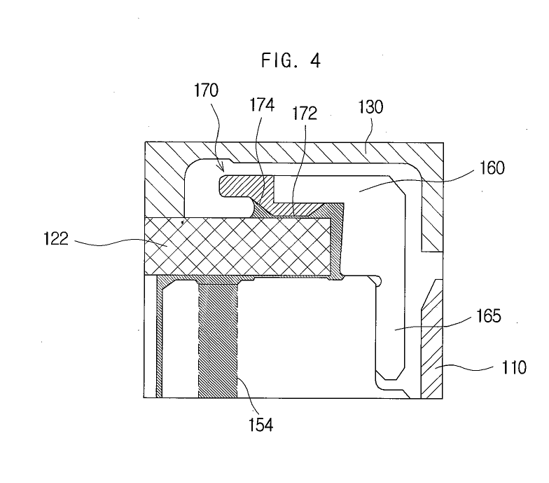

FIG. 4 is a magnified view illustrating a portion of the spindle motor 100 in accordance with an embodiment of the present invention. As illustrated in FIG. 4, the lubricant filled between the end of the sealing part 170 and the plate 122 forms a concave-shaped surface by the surface tension of the lubricant, thereby preventing the leakage of the lubricant by the self-sealing effect. Additionally, it can be determined whether a sufficient amount of lubricant is filled because the sealing part 170 is made of a transparent material, as described above.

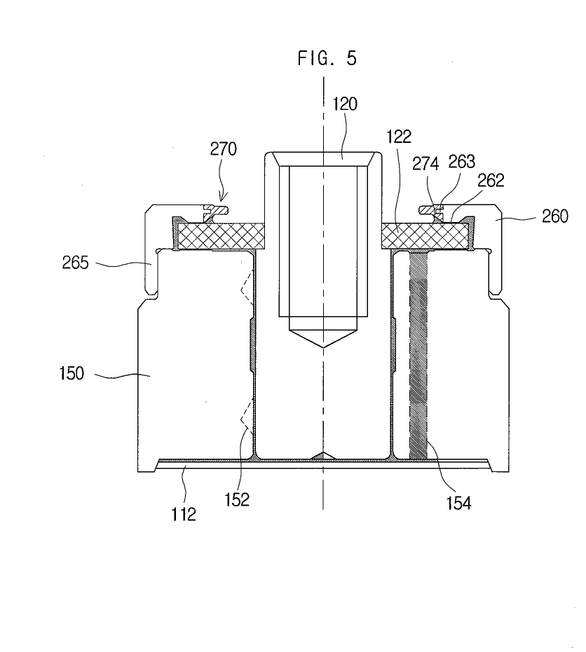

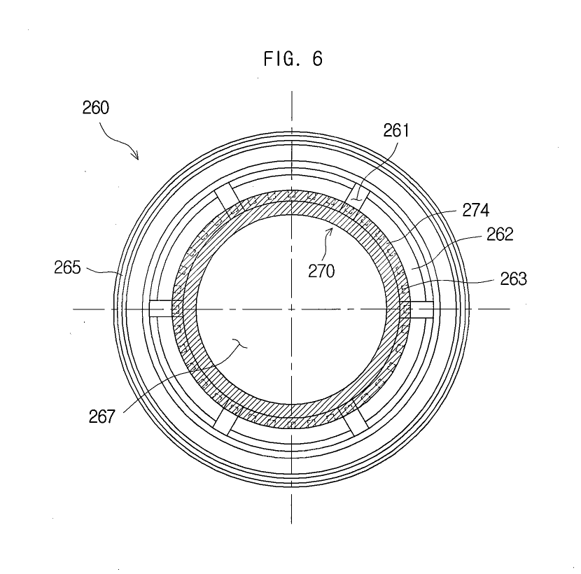

FIG. 5 is a cross-sectional view illustrating a portion of a spindle motor in accordance with another embodiment of the present invention, and FIG. 6 is a bottom view illustrating a cap 260 of a spindle motor in accordance with another embodiment of the present invention. FIG. 5 will not be used here to describe the present embodiment, and as the same components illustrated in FIG. 1 are not redundantly illustrated in FIG. 5, detailed description of the same structure described above will be omitted hereinafter.

As illustrated in FIGS. 5 and 6, a supporting protrusion 262, which is protruded downward, is formed on a lower surface of the cap 260, in which the lower surface of the cap faces the plate 122. The supporting protrusion 262 can reduce a contact area between the plate 122 and the cap 260, allowing the rotor 130 to rotate smoothly. Since the supporting protrusion 262 is a portion of the cap 260 made of a hard metal material, the wear caused by the friction with the plate 122 can be effectively controlled.

A fixing protrusion 263 protruded inward is formed on an end of the cap 260. The fixing protrusion 263 is a part for structurally supporting a sealing part 270 such that the sealing part 270 can be easily coupled to the end of the cap 260.

A flowing groove 261 can be radially formed from a lower surface of the sealing part 270 to the lower surface of the cap 260 facing the plate 122.

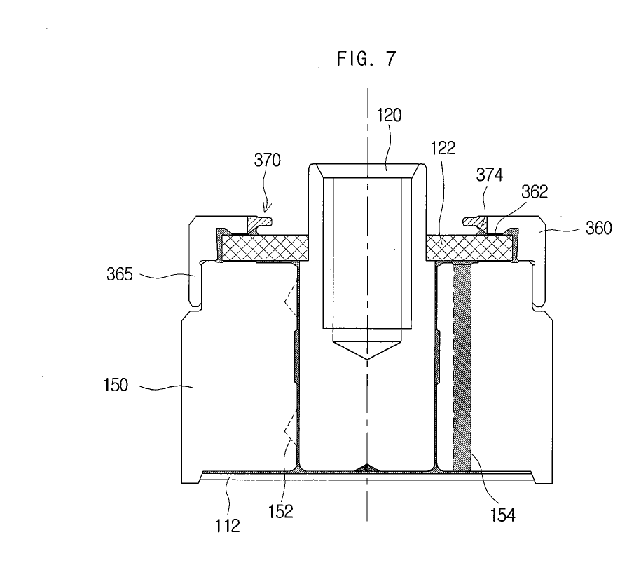

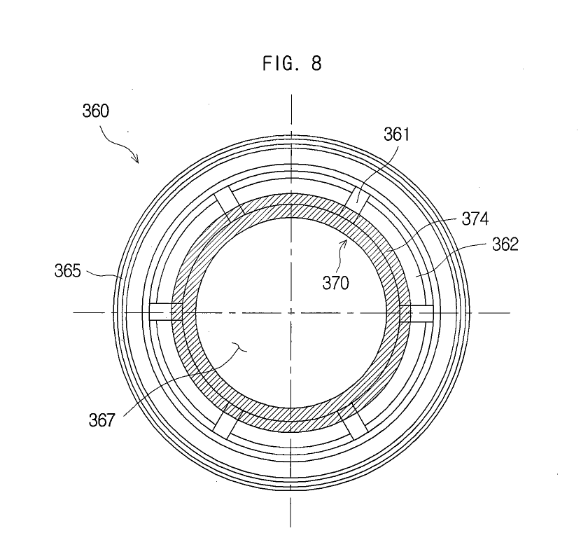

FIG. 7 is a cross-sectional view illustrating a portion of a spindle motor in accordance with yet another embodiment of the present invention, and FIG. 8 is a bottom view illustrating a cap 360 of a spindle motor in accordance with yet another embodiment of the present invention. FIG. 7 will not be used here to describe the present embodiment, and as the same components illustrated in FIG. 1 are not redundantly illustrated in FIG. 7, detailed description of the same structure described above will be omitted hereinafter.

As illustrated in FIGS. 7 and 8, if a sealing part 370 can be reliably coupled to an end of the cap 360, all the sealing part 370 and the cap 360 can be formed in a simple structure, thereby saving the cost to manufacture the sealing part 370 and the cap 360. Particularly, if the cap 360 is made of a hard metal material, the effectiveness of cost reduction will be maximized due to the simple structure.

While the spirit of the invention has been described in detail with reference to particular embodiments, the embodiments are for illustrative purposes only and shall not limit the invention. It is to be appreciated that those skilled in the art can change or modify the embodiments without departing from the scope and spirit of the invention. As such, many embodiments other than those set forth above can be found in the appended claims.

What is claimed is:

1. A motor comprising:
a rotor;
a shaft coupled to the rotor;
a plate coupled to an outer circumference of the shaft;
a bearing configured to support the shaft such that the shaft can rotate;
a cap coupled to the bearing such that an edge of the plate is covered;
a lubricant filled between the shaft and the bearing; and
a sealing part coupled to an inner side of the cap, the sealing part being made of a transparent material such that an amount of the lubricant filled can be checked.

2. The motor of claim 1, wherein an end of the sealing part is tapered toward the shaft.

3. The motor of claim 1, wherein a supporting protrusion is formed on a lower surface of the sealing part, the supporting protrusion being protruded downward.

4. The motor of claim 1, wherein a flowing groove is radially formed on a lower surface of the sealing part.

5. The motor of claim 1, wherein a supporting protrusion is formed on a lower surface of the cap, the lower surface facing the plate, the supporting protrusion being protruded downward.

6. The motor of claim 1, wherein a flowing groove is radially formed on a lower surface of the cap, the lower surface facing the plate.

7. The motor of claim 1, wherein the bearing is a hydrodynamic bearing.

8. The motor of claim 7, wherein a dynamic pressure groove is formed on an inner circumference of the hydrodynamic bearing, the dynamic pressure groove being tilted from the axis of the shaft.

9. The motor of claim 8, wherein a through-hole is formed on the bearing, the through-hole penetrating through the bearing vertically such that the lubricant flows.
